(19) United States
(12) Patent Application Publication
(10) Pub. No.: US 2012/0331118 A1
(43) Pub. Date: Dec. 27, 2012

(54) System and method for hosted dynamic case management

(75) Inventors: Alex Stein, (US); Igor Duvidson, Studio City, CA (US); Sergiy Kaz, Los Angeles, CA (US)

(73) Assignee: Eccentex Corporation

(21) Appl. No.: 13/135,074

(22) Filed: Jun. 24, 2011

(51) Int. Cl. G06F 15/16

(52) U.S. Cl. 709/223

(57) ABSTRACT

According to a preferred embodiment, the system comprises a configuration server, a dynamic case management (DCM) application development platform, a dynamic case management (DCM) model store, and a multitenant runtime platform. The DCM application development platform further comprises a business object builder, a presentation builder, a rule builder, a report builder, a dashboard builder, and a business process builder. The multitenant runtime platform further comprises a business data server, a rules processor, a content management server, a desktop renderer, a report server, a dashboard server, an audit server, an alert server, and a runtime security server. According to the embodiment, the runtime platform is adapted to operate in either of a shared multitenant application deployment model and a direct multitenant application deployment model.

### BACKGROUND OF THE INVENTION

1. Field of the Invention

The present invention is in the field of dynamic case management software solutions, and more particularly in the field of delivering dynamic case management platforms as a service.

2. Discussion of the State of the Art

For many years, businesses have struggled to optimize the efficiency and productivity of their internal business processes, adopting such well-known management paradigms as total quality management, lean and six sigma. In parallel, a large number of technologies have emerged to facilitate the increasing focus on management of business processes, among these a growing number of business process management (BPM) platforms. However, these platforms have suffered from two major disadvantages that have effectively served to preclude their use in the management of many large classes of important business processes. The first disadvantage is that most BPM platforms are designed to be deployed (or at least used) by single enterprises. Generally, information technology (IT) staff of an enterprise will deploy and configure BPM applications, sometimes with the help of outside systems integrators, entirely within their own enterprise. This is a problem because many business processes naturally take place across enterprise boundaries. For example, users of mobile phones who have lost their devices will generally call the carrier from whom they have been receiving service, and the carrier will bring in a specialized insurance company that insures mobile phones, tracks fraud, and handles losses. Actual fulfillment of any approved phone replacement might be carried out by yet another enterprise, such as a handset manufacturer. All three of the enterprises cited in this example are working under the brand of, and at the behest of, the mobile carrier, yet each will generally independently manage its internal business processes. As a result, key information is often lost as a “case” (in this case, the lost mobile phone incident) migrates from one owner to another across enterprise boundaries.

The second major problem with current BPM systems is that they generally are organized around a traditional, procedural programming model in which highly technical IT staff (or systems integrators) develop BPM applications using traditional programming languages such as Java, taking advantage of special BPM application programming interfaces (API) to access services provided by BPM platforms. There are two issues resulting from this situation. First, only very technical individuals are able to make changes to BPM applications (that is, to the systems intended to automate business processes), while the people who actually manage the affected business processes are limited to writing detailed requirements and business cases, fighting for budget, and then waiting for a typically six-month change management cycle to get their changes made. Secondly, procedurally programmed BPM applications are only suitable for a subset of the major categories of business processes—those which can be explicitly defined at design time with a high degree of precision (for example, processing a loan application). Many valuable contributions have been made over the last two decades to the productivity of our economy by BPM applications despite these constraints. Unfortunately, however, many mote business processes exist within enterprises that are not easily reduced to a reasonably small set of static rules that can be coded in to a BPM application.

What is needed is a dynamic case management platform that facilitates the management of complex, adaptive business processes—even across enterprise boundaries—and that support a highly flexible application composition model that can be configured by line-of-business staff that actually manages the underlying business processes.

### SUMMARY OF THE INVENTION

In order to meet these needs, the inventor has conceived a dynamic case management system intended for operation in the cloud (for example, as a web-based service) that supports an easy-to-use, flexible dynamic case management application composition paradigm utilizing an underlying application library. According to a preferred embodiment, the system comprises a configuration server, a dynamic case management (DCM) application development platform, a dynamic case management (DCM) model store, and a multitenant runtime platform. The DCM application development platform further comprises a business object builder, a presentation builder, a rule builder, a report builder, a dashboard builder, and a business process builder. The multitenant runtime platform further comprises a business data server, a rules processor, a content management server, a desktop renderer, a report server, a dashboard server, an audit server, an alert server, and a runtime security server. According to the embodiment, the runtime platform is adapted to operate in either of a shared multitenant application deployment model and a direct multitenant application deployment model.

### BRIEF DESCRIPTION OF THE DRAWING FIGURES

FIG. 1 is a block diagram of components of the invention according to a preferred embodiment.

FIG. 2 is a block diagram illustrating a security model for handling multiple independent tenants, according to an embodiment of the invention.

FIG. 3 is a block diagram showing a method for providing direct multitenant applications, according to an embodiment of the invention.

FIG. 4 is a block diagram showing a method for providing shared multitenant applications, according to an embodiment of the invention.

FIG. 5 is a block diagram showing a multi-enterprise business process carried out according to an embodiment of the invention.

### DETAILED DESCRIPTION

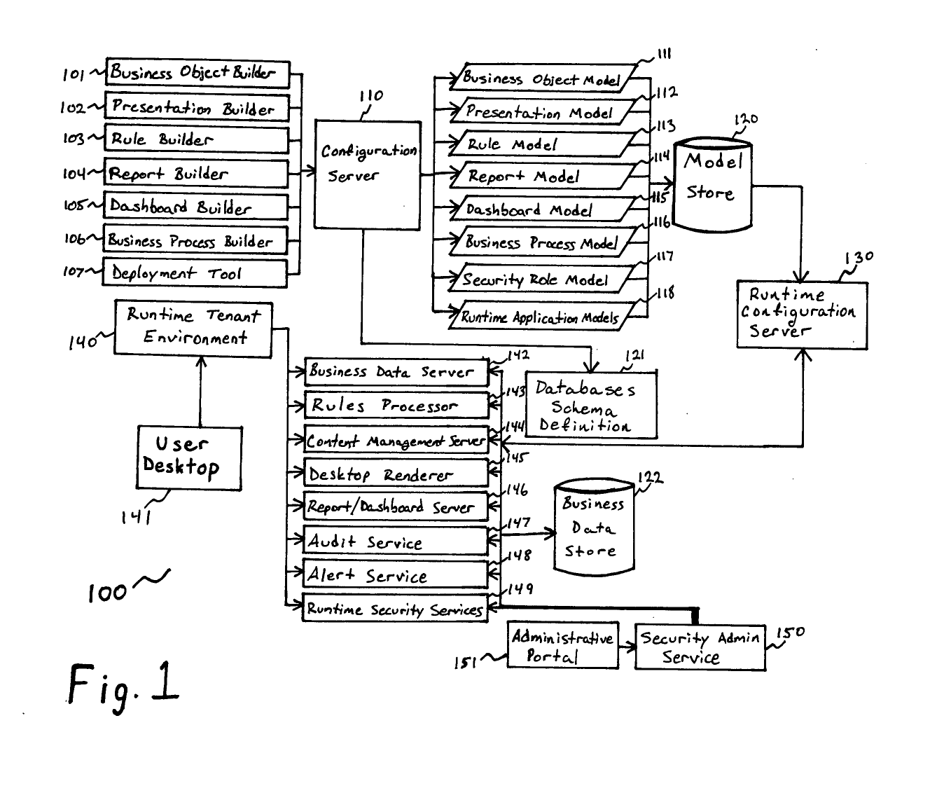

The inventors provide, in a preferred embodiment, and referring to FIG. 1, a system 100 that provides a dynamic case management (DCM) platform suitable for use in a “platform as a service” (PaaS) model. That is, systems 100 according to the embodiment can be deployed “in the cloud”, or in a public network, where it is accessible to a potentially large number of users from many different enterprises. While the inventor contemplates deployment of system 100 as a cloud-based platform-as-a-service, it should be appreciated that system 100 could as easily be deployed within an enterprise or even on a single computer, if desired, without departing from the scope of the invention. System 100 enables non-technical “business users”—the individuals who typically have responsibility for managing complex business processes such as insurance claims adjustment, crime investigations, and complex technical support operations—to configure flexible DCM applications, appropriate for use with complex business processes in the real world, using an ordinary web browser. Furthermore, system 100, by nature of its role as a cloud-based platform, is capable of managing complex business processes that span multiple enterprises, allowing data and events to flow across enterprise boundaries, subject to configurable security rules, in order to allow a plurality of enterprises to collaborate in delivering value to their joint customers (for example). Another example of the importance of being able to transcend enterprise boundaries is that a single enterprise, to deliver a complex service to its customers, is able to make use of specialized third-party service components that are located neither in their own enterprise nor in system 100, but in a facility of a specialized cloud-based service provider (who might, for instance, provide a service that checks potential transactions for indications of likely money-laundering).

System 100 is comprised of numerous functional components, which will each be described herein. It should be noted at the beginning, however, that the arrangement illustrated in FIG. 1 is exemplary in nature. As is well-known in the art, many alternative configurations are possible using modern computing technologies such as virtual machines (many logically independent elements operating on a single physical machine, and behaving as if they were separate computers) and clustering (a single logical component, such as a database management system, appearing to its clients as a single machine at a single network address, but in fact comprised of many closely-interoperating machines). For example, in general any combination of components illustrated in FIG. 1 could be arranged physically together, either on one physical server computer or on a single virtual server computer. Similarly, any single component can, when appropriate, be distributed across many physical machines. Additionally, there are several database-type components in system 100 (for example, business data store 122 and model store 120), and these may operate together within a single database management system or on separate database management systems without departing from the embodiment. Furthermore, some components such as configuration server 110 can be implemented as stored procedures within a database management system, or as standalone programs operating on a server, or even as scripted web pages operating on a conventional web server or web application server. What should be clear to one having ordinary skill in the art that the inventor's conception lies not in any particular programming language or architectural choices, but in the collection of functional elements, arranged together, that make it possible to deliver; as a service, a robust, scalable, secure, and easily configurable dynamic case management platform.

A central concept to the inventor's conception of a DCM PaaS system 100 is the notion of a DCM application. According to the invention, a DCM application (or application model) is a set of data that specifies all relevant rules and configuration data necessary to execute, at runtime, a specific dynamic case management process. DCM applications are developed, according to a preferred embodiment of the invention, using a dynamic case management (DCM) application development platform 108, which is accessed by users via ordinary web browsers. DCM application development platform 108 comprises a number of “builder” services, which are specialized web applications, typically delivered to a browser via a web server (not shown), each providing a development environment suitable for the building of particular parts of a DCM application. Of course, as described above, in many cases all of the builders provided by DCM application development environment 108 will be delivered from a single web server or web application server, and also in many cases the separate builders are each provided via a separate tab within a DCM application development web page provided by development environment 108. Generally, each builder provides a graphical, drag-and-drop style interface for building various models relevant to an intended DCM application. Users can generally start a new model from scratch, or they can load a predefined model, either of their own or another's design, for use a starting point when building or editing specific models.

Business object builder 101 provides, as described above, a graphical, web-based user interface that allows users to build or edit business object models 111. Each DCM application has as a base component one or more business object models 111. Business object models 111 are used to define types of business data a particular application will use, and it defines relationships between data elements. For example, in many DCM applications a main business object is “case”, which represents an instance of an end-to-end.complex process. Examples of cases include murder investigations, insurance claims adjustments, unemployment insurance benefit applications, litigation matters, and so forth. Typically; dynamic case management systems are built around cases. Usually there are many other “business objects” in any given application, such as “client”, “provider”, “account”, and so forth. Each business object model 111 comprises many business objects, and each business object typically has one or more attributes. For example, business object “client” will typically contain attributes “Last Name”, “First Name”, “Street Address”, and so forth. Each business attribute in turn has a property called “data type”; for example, “Last Name” and “First Name” would be of type “Text”, whereas a business attribute “Date of Birth” might be assigned type “Date”. Typically, although not necessarily, business object attributes will also contain certain additional properties, such as “Length”; each business object attribute can be assigned any number of properties, and properties can optionally be provided with default values.

A second key part of business object model 111 is a set of relationships between business objects. Relationships can be viewed as “links” from one business object to another. For example, a “Client” business object may be linked, through a relationship, to a “Provider” who has been assigned to be their primary contact within an enterprise. Another important example is that “Case” objects typically are linked to a “Client”, and may also be linked to an assigned case manager who is a “Provider”. When relations are properly established, it becomes possible to establish “views” across a given DCM application, such as “all cases assigned to members of provider group A, with the cases' current status”—this query or report would relay on links between “Cases” and “Providers”, between “Providers” and “Groups”, and it would also rely on each case's “Status” attribute. Relations can be one-to-one, one-to-many, or many-to-many; it will be appreciated by one having ordinary skill in the art that there are many modeling tools and languages capable of fully representing sets of objects and relations, and that any of them can be used according to the invention. Typically, business object builder 101 is used to define objects, their relations, and their attributes (or to edit those definitions), and a person whose role is to create a DCM application uses business object builder 101. Actual creation of instances of business objects is normally carried out at runtime by end users. However, it is contemplated by the inventor that users of business object builder 101 will sometimes create a small number of instances of business objects, and typically business object builder 101 will provide facilities for doing so.

Configuration server 110 acts as an intermediary between DCM application development environment 108 and various models (such as business object model 111). Configuration server 110 in some embodiments enforces security rules, ensuring that no changes to models are made by unauthorized persons using DCM application development environment 108 (although normally this role is performed by DCM application environment 108 itself, checking security rights of each user as the user logs in to one or more builders). Additionally, configuration server 110 in some embodiments validates proposed changes or additions to models against one or more data integrity rules. In particular, configuration server 110 will generally enforce tenant data integrity rules. Since system 100 is intended to operate in a multitenant environment—that is, in an environment where many users from many different enterprises are using system 100 at any given time—it is important that, throughout system 100, rules regarding data integrity between tenants be enforced. For example, one tenant (enterprise) may create a particularly sophisticated client business model, and the tenant may desire that the model be kept invisible to other tenants. In other cases, either the operator of system 100, or a third party, or even another tenant, may build various models that are intended to be viewable (or even editable) by all or a subset of possible tenants.

While configuration server 110 acts as an intermediary between builders and models, it also provides access for builder components to predefined database schema definitions 121, which can then be used as a template from which to build new models. For example, in some embodiments database schema definitions 121 will contain predefined “Client”, “Provider”, and “Case” schemas that can be used as the basis for corresponding, tenant-specific models to facilitate quicker application development.

Business object model 111 and all other models defined within DCM application development environment 108 are stored in model store 120, which in a preferred embodiment is a relational database system (although, as mentioned above, it could be any type of data storage system known in the art, even a flat file).

Presentation builder 102 allows application designers to graphically (typically using drag-and-drop interface style) specify user interface elements that will be used, at runtime, by users of system 100. Such specified interface elements are assembled in presentation model 112 and stored in model store 120. For example, various screens for searching, editing, creating, and deleting various types of business objects can be specified. Such screens could be object-specific (for example, an “Add a Client” screen, which might not only allow a user to add a new client but also walk the user through a series of related steps required to be performed whenever a client is added), or general (for example, a general “Search” page which might include a pull-down list to specify the types of objects to be included in search results, and a series of fields for specifying search query parameters—such a search page could be used to search for objects of any type and is thus general). Presentation builder 102, in some embodiments, allows creation of hierarchical presentation models 112 comprising a plurality low-level presentation elements such as “Account—Short Form” and “Account—Long Form” and a plurality of higher-level elements such as predefined pages, which are assembled by placing low-level elements on them in specific layouts or locations.

Rule builder 103 provides a web-based user interface to allow a DCM application designer to specify or edit business rules that will be used to drive application behavior at runtime. Business rules for a particular DCM application created or edited in rule builder 103 are assembled in rule model 113 and stored in model store 120. Rule builder 103 is, in some embodiments, a graphical, drag-and-drop style web page, but rule builder 103 may also be of a more text-oriented style, for instance with a table for rule elements that can be populated by a DCM application designer, possibly using pull-down lists or other well-known user interface widgets or elements to facilitate easy rules configuration. Rules are created using other elements previously created within DCM application development environment 108. For example, a rule might be created stating: “If CLIENT has more than two ACCOUNTS, and the sum of all BALANCES within all of CLIENT'S ACCOUNTS is more than $150,000, then set CLIENT'S SEGMENT to 5”. The capitalized words are names of business objects or their attributes, all of which would have been previously defined within business object builder 102, and thus available within rule builder 103.

Report builder 104 provides a web-based user interface to allow a DCM application designer to specify or edit reports that will be provided to end users at runtime. Reports for a particular DCM application created or edited in report builder 104 are assembled in report model 114 and stored in model store 120. Report builder 104 is, in some embodiments, a graphical, drag-and-drop style page, but report builder 104 may also be of a more text-oriented style, for instance using a tabular format (which is commonly how reports are delivered and consumed). Reports stored in report model 114 may be stored in a number of ways known in the art, including extensible markup language (XML), including possibly of a specialized variant designed for reporting, such as Report Markup Language (RML). However, it will be clear to one having ordinary skill in the art that there are a large number of well-established ways to store report-related data, any of which can be used according to the invention.

Dashboard builder 105 and dashboard model 115 are in many ways analogous to report builder 104 and report model 114, and in fact the two could be combined. Dashboards tend to be more real-time and graphical in their presentation of data, but basically serve the same function as reports.

Business process builder 105 provides a graphical, web-based user interface that allows drag-and-drop composition of complex business processes. In marked contrast with typical business process management platforms, where process definition is typically done in either code or in a code-like markup language, business process builder 105 allows a non-technical user to compose or assemble complex processes without writing (or even seeing) any code. Processes are built up using elements previously defined with DCM application development environment 108. Business rules defined in rule builder 103 can be used to filter a set of objects or to determine which execution branch to take. Reports and dashboards defined in report builder 104 and dashboard builder 105 can be updated or sent to specified individuals from within a business process. Business processes designed within business process builder 106 are assembled in business process model 117 and stored in model store 120. In many cases, according to preferred embodiments of the invention, business processes are designed hierarchically. For example, fairly focused and commonly-used business processes such as “validate risk factors” or “update customer address” may be defined once and then included as sub-processes within larger, more complex business processes, such as “originate home mortgage loan”.

An overall DCM application, generally corresponding to some highest-level business process, can be assembled using deployment tool 107. Assembling a DCM application essentially means specifying processes to be carried out under the application, reports and dashboards to be provided to managers responsible for the process (or for the line of business that carries out the process, or for a geographic territory, and so forth), and presentation elements to be provided to end users who actually carry out the process. Also, deployment tool 107 allows a designer to specify that an application can be added to a public application library, and optionally to specify rules about who may access the application (and for what price), either to run it as is or to use it as a template from which to design their own derivative application. When an application is assembled, it is placed in runtime application models 118 and stored in model store 120.

As can be seen from the descriptions above of the various builders and models associated with system 100, DCM applications are comprised of a plurality of interrelated models stored in model store 120. Runtime configuration server 130 is responsible for providing current models to various components of DCM runtime engine 139, and for notifying runtime components when models underlying their operation are changed. This is important as a designer may elect to modify an existing model that has already been deployed into production (that is, a model that is actively running in DCM runtime engine 139), with potentially hazardous results. When the designer in such a situation deploys the modified model using deployment tool 107, and the associated runtime application model 118 is updated, then runtime configuration server 130 is responsible for properly notifying DCM runtime engine 139 of the change. Changes to existing, and possibly running, applications can be made in a variety of ways, each with advantages and disadvantages. Consider what happens when a business process is modified, for instance by deleting a step. If the change is implemented immediately, then clearly a designer's intent is given immediate effect, which can be seen as a definite advantage (particularly if the designer is fixing a problem with an existing business process). But if there are many instances of the effected business process currently running when the change is made by the designer, some of them may have already taken the now-deleted step, others may be just about to take the now-deleted step, and still others may be much earlier in the process. In this case, if the change is effected immediately, then an instance of the process which just passed the now-deleted step would be unaffected, but an instance just approaching the now-deleted step would not take that step, thus differentiating it from the first instance (that had already passed the point). Now the runtime engine is handling multiple instances of the same business process, which are distinct in that some had the now-deleted step performed, some didn't, and some have yet to reach the point in question. If one considers reports generated based on operation of many instances of the business process, it will be very difficult to know how to handle this situation from a reporting (or dashboard) point of view. One could, of course, track performance on a per-application-version basis, which would clearly separate the original business process from the business process with a deleted step (which would have a different version number, managed by configuration server 110 or runtime configuration server 130). Or, reports could be generated based on a per-application (business process) basis, and the loss of certainty (which would be minor) could simply be tolerated. Another approach would be to only put the change into effect in DCM runtime engine 139 when there are no instances of the affected business process being executed by DCM runtime engine 139. This has the advantage that no confusion will exist from having multiple versions executing simultaneously, but it has the possibly important side effect that the time when a given change will actually be implemented in DCM runtime engine 139 cannot be known in advance, since it will not be clear when the first time will occur when there are no instances of the affected business process running (indeed, it could be days before that happens). Yet another approach would be to make a change at a predetermined time, generally corresponding to a boundary between reporting time intervals (for instance, at the end of a day or an hour). Yet another approach would be to only implement the changed version of the application (business process) for instances of the business process that start after the change has been loaded. That is, all instances that were running when the change was loaded will ignore the change, while all newly-instantiated instances will use the new version. Clearly there are many possibilities, any of which may be used according to the invention.

Business data store 122 is a data repository for “real world” data. Whereas model store 120 stores abstract models of, for example, a generic client, business data store 122 stores data about actual clients. The structure of data stored in business data store 122 corresponds to the applicable models stored in model store 120, but the content will be specific to each individual client (or other business object). Another way to view this relationship is to consider that model store 120 contains empty, abstract descriptions of particular classes of objects (“clients”, “cases”, etc.), with no data (except possibly default values) stored, and with only one record stored per type of object. Thus model store 120 stores a single model of “client” (although it should be noted that there may be many distinct abstract models of “client”, each one representing a particular model version for a particular tenant), to which all clients actually conform. Business data store 122, on the other hand, contains populated instances of objects, each corresponding in structure to the corresponding abstract model but populated with real data. Moreover, business data store 122 will store data corresponding to many clients (for example), each containing data pertaining to that specific client Model store 120 is populated by DCM application development environment 108, whereas business data store 122 is populated by DCM runtime engine 139.

During runtime operation, users interact with system 100 via a user desktop 141, which could be a web page displayed within a browser or a dedicated application. Moreover, user desktop 141 could be a mobile application running on a mobile phone or a tablet computing device. It will be appreciated by one having ordinary skill in the art that there are many ways for a user to interact with a platform, and any of these may be used to implement user desktop 141. User desktop 141 interacts with system 100 through a runtime tenant environment 140, which manages tenant-specific data security rules and ensures that any given tenant does not bring down the entire system 100, for example by being a target of a denial-of-service attack. In some embodiments, runtime tenant environment 140 carries out a caching function, caching data (that is, business objects) that are frequently used so that repeated queries to business data server 142 are not required. In such embodiments, any of various means known in the art can be used to ensure that cached data is kept up-to-date, for instance, by having business data server 142 send a notification to runtime tenant environment 140 when a business object has been changed, particularly if runtime tenant environment 140 has previously notified business data server 142 that it is caching the business object in question.

While users interact with DCM platform 100 via user interface 141, which in turn passes all requests and receives all responses from runtime tenant environment 140, execution of actual DCM applications in runtime takes place in DCM runtime engine 139, which is a collection of web-based servers (or services; the two terms can be considered synonymous), each carrying out a distinct subset of an application's functionality, and each based on corresponding models stored in model store 120. Business data server 142, which is driven by business data model 121, provides access to business objects (data) in runtime. As described above, business data representing actual business objects is stored in business data store 122, to which business data server 142 has access. Rules processor 143 is a rules engine analogous to those well-known in the art, and has the function of processing business rules defined in rule model 113, applying actual data in the execution of rules. For instance, the rule described above regarding client segmentation was defined in rules builder 103 without reference to actual client data, but when the rule is executed by rules processor 143 the rule is evaluated with actual data (in this case, using actual values for CLIENT, ACCOUNTS, account BALANCES, and populating the field SEGMENT of the CLIENT business object in accordance with the rule, based on the actual values).

Content management server 144 is a service that provides well-understood enterprise content management functionality, and which thereby ensures accuracy and currency of any content provided to a user in conjunction with a DCM application. For example, if a user is a loan officer considering a complex loan application, the user might have need, during the course of managing the case (the complex loan application), to conduct a review of certain specific regulations pertaining to the type of loan requested. The required content would be served up by content management server 144, and the user would not have to manually check to make sure she had the most current information. Desktop renderer 145 uses presentation models 112 to populate user interface 141 with user interface elements as designed in presentation builder 102. Similarly, report/dashboard server 146 uses report model 114 and dashboard model 115 to populate and render reports and dashboards via user interface 141.

Audit service 147 tracks all usage of DCM runtime engine 139, and stores all usage-related data in business data store 122. Audit service 147 is configured using runtime configuration server 130, for example by specifying what types of actions or events are to be captured and retained for audit purposes, and by specifying what types of audit reports will be prepared (and how often they will be prepared).

Alert service 148 has the role of providing alerts to users (via user interface 141, or via notification via email, short message service, instant messaging, or any other means known in the art) when configurable alert conditions are met. For example, an alert may be triggered when an elapsed time for carrying out a certain step in a certain business process has been missed. Such an alert would be configured in two parts. First, in the relevant business application's rule model 113, a rule would be configured that states that, if a certain action isn't taken within a specified time, an alert should be generated. Second, actual parameters used to send the requested alert are determined by alert service 147. For example, the identities of personnel to whom the alert is to be sent would be determined by executing a query to business data service 142 (because roles and responsibilities of individuals associated with tenants are provided as attributes of the respective business objects). In some cases, alerts are sent to staff of DCM platform 100 rather than personnel of any specific tenant; in such cases, configuration information required may be obtained either from business data server 142 or from runtime configuration server 130.

Runtime security service 149 enforces security roles of all individuals interacting with DCM runtime engine 139, particularly by preventing unauthorized actions from taking place. In some embodiments, when an unauthorized action is attempted, an alert request may be generated and sent to alert service 148 to notify appropriate people. Security rules and parameters are configured by DCM platform 100 personnel using administration portal 151, which provides configuration data to security admin service 150, which maintains all security administration data and rules. In some embodiments, comprehensive audit data is passed by audit service 147 to security admin service 150 so that DCM platform 100 staff is able to review any aspect of security.

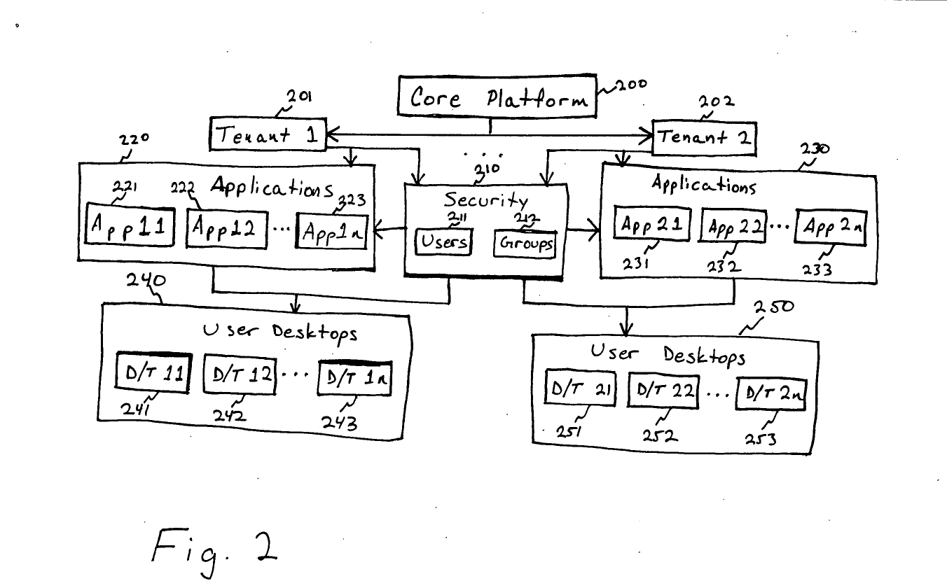

FIG. 2 is a block diagram illustrating a security model for handling multiple independent tenants, according to an embodiment of the invention. Core platform 200 comprises services that are applicable to, and used by, many or all DCM applications operating on DCM platform 100, for example audit service 148, alert service 149, and various databases such as model store 120 and business data store 122. Access to core platform 200 elements is generally limited to DCM platform 100 staff, in an analogous way to the division of access rights in Unix™-like systems between those having root access to a machine, and those having access as users with specified rights within “user space”. According to preferred embodiments of the invention, tenants 201, 202 have certain security rights that apply to all users and applications operating within tenants' 201, 202 subdomain (that portion of users, data, and active applications associated by platform 200 with tenant 1 201 or tenant 2 202, for example). Each tenant 201, 202 has a plurality of DCM applications 220, 230, configured as described above with reference to FIG. 1. For example, tenant 1 201 has provisioned and operates applications 11 221, 12 222, and 1n 223, where n is a number representing a total number of applications configured on behalf of tenant 1 201. Similarly, tenant 2 202 has provisioned and operates applications 21 231, 22 232, and 2n 233, with n here representing a number of applications configured on behalf of tenant 2 202. Note that while two tenants are needed to illustrate certain aspects of a security model according to the embodiment, in most cases there will be many more than two tenants making use of DCM platform 100 at any given time.

While, according to the embodiment, each tenant 201, 202 has complete control of, and responsibility for, applications configured on their behalf, a common security model 210 applies to all tenants subscribing to services provided by DCM platform 100. Security model 210, again in a way that is analogous to the well-known Unix™-style security model, maintains a single database of users 211, and a second database of groups 212, to which users 211 may belong. It is important to have a common security model 210, since if each tenant were to independently manage security, problems such as poor security administration or duplicate user names across DCM platform 100 could easily occur, rendering DCM platform 100 potentially unsafe for all tenants, rather than just an offending tenant.

Tenant 201 enables interactions between users and DCM platform 100 by providing a plurality of user desktops 240, including for example desktop 11 241, desktop 12242, and desktop 1n 243, where n represents a number of user desktops enabled by tenant 201. Similarly tenant 2 202 enables interactions between users and DCM platform 100 by providing a plurality of user desktops 250, including for example desktop 21 251, desktop 22 252, and desktop 2n 253, where n represents a number of user desktops enabled by tenant 202.

As can be seen in FIG. 2, each user desktop interacts directly with one or more applications configured on behalf of its associated tenant, while simultaneously having security rules enforced by common security engine 210. For example, when a user using desktop 11 241 begins a new session at the beginning of a shift, she is required (by security engine 210) to successfully login. Login credentials are checked by security engine 210 to prevent unauthorized access to tenant applications or to core platform 200. Similarly security engine 210 enforces access rules intended to prevent, for example, denial of service attacks (potentially by looking for multiple logins from a small range of IP addresses, using user identities from multiple tenants 201, 202). Once a user has been successfully validated and logged in, a token or datagram is sent, according to some embodiments, from security engine 210 to the appropriate tenant 201, 202 (the tenant to whom the user in question belongs), advising tenant 201, 202 of the identity and validated status of the user. Tenant 201, 202 then provides access to applications 220, 230 as appropriate for the individual user's allowed roles and access rights (which can be obtained from security engine 210).

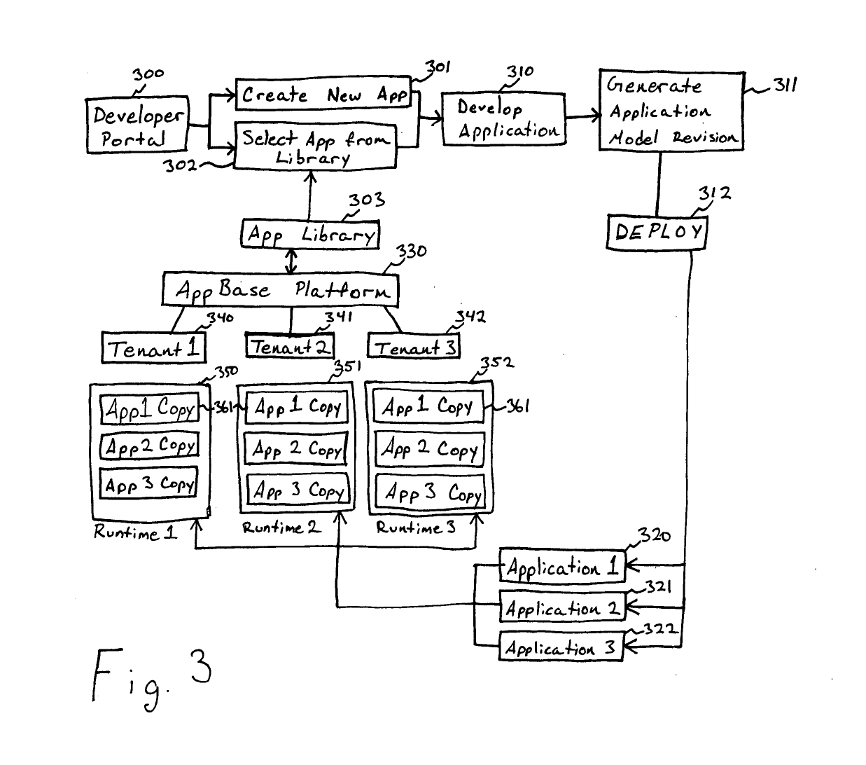

FIG. 3 is a block diagram showing a method for providing direct multitenant applications, according to an embodiment of the invention. According to the embodiment, a user interacts with developer portal 300 to design, configure, and deploy DCM applications. A user may elect to create a new application in step 301, or may alternatively elect to select an application, in step 302, from application library 303, for use as is, or as a template for further configuration. If a user elects to create an application in step 301, the user is typically prompted (within developer portal 300) to enter a name for the application, and the user may optionally specific access restrictions to the application. If the user elects to start with a prebuilt application from application library 303, the user may elect to use the application as is, or she may elect to use the selected application as a starting point to facilitate quicker application design and configuration. Once an application has been selected or initiated, it is designed in detail by the application developer (or designer; the two terms may be used interchangeably herein) in step 310. This step may take place over numerous sessions wherein the developer or designer interacts with developer portal 300, with designers having the ability to save work between sessions. Designers access, via developer portal 300, all features provided by DCM application development environment 108, in particular the various model builders such as business object builder 101, presentation builder 102, and the like. In some embodiments, applications being actively designed are saved as sets of working data by system 100, so that until a designer has finished work (possibly over many sessions), others will not have access to the application under design. In other embodiments, collaborative application design and development is enabled (that is, step 310 may be carried out for a particular application by a plurality of users (developers/designers), potentially across a plurality of sessions separated in time, each user working with intermediate work product designed earlier by the same or other users.

When a developer, or a set of developers, is satisfied with a developed application, the developer generates an application model revision in step 311. In some embodiments, applications are assigned a new revision in step 311 as soon as any changes from a previous version are saved, even if the application is not yet considered complete by the designer. It will be appreciated by one having ordinary skill in the art that many sophisticated tools have been made available in the art for the management of collaborative development and software version control, any of which may advantageously be used in conjunction with embodiments of the invention. Once a new version of an application has been tested, it is deployed in step 312.

Deployment means the application is configured for use within DCM runtime engine 139.

According to a preferred embodiment of the invention, applications 320-322 are made available to a plurality of tenants (although some applications may be designated as tenant-specific and limited to use by the relevant tenant). It is advantageous, according to the invention, to make applications available for direct copying and use by multiple tenants, in order to facilitate various models of collaboration and sharing with regard to applications. For example, in some embodiments third party specialist application developers (or even staff of DCM platform 100) may elect to build certain preconfigured applications in anticipation of selling, renting, or sharing them to (or with) one or more tenants 340-342. In other embodiments, an application built by one tenant (for example, tenant 1 340) might be made available to others in anticipation that those others might similarly share their home-grown applications. In yet other embodiments, some applications may be developed by a plurality of tenants 340-342 working together, in order that the applications may be used by them collectively to manage complex business processes that are carried out by more than one enterprise. In any case, applications 1-3320-322 may be deployed directly by tenants 1-3 340-342 by loading a copy of an application 320-322 into runtime tenant environment 350-352 (corresponding to runtime tenant environment 140 in FIG. 1). This, for example, if all three applications 320-322 were to be used by all three tenants 340-342 as shown in FIG. 3, then each runtime tenant environment 350-352 would have a copy 361 of each application. It should be noted that applications 320-322 are made available for loading into tenant runtime environments 350-352 via business data store 122. In some cases, it will be desirable to make successful applications available for use in building improved versions. In this situation, applications 320-322 would be loaded into a DCM application library 303, which generally (but not necessarily) would be stored in model store 120.

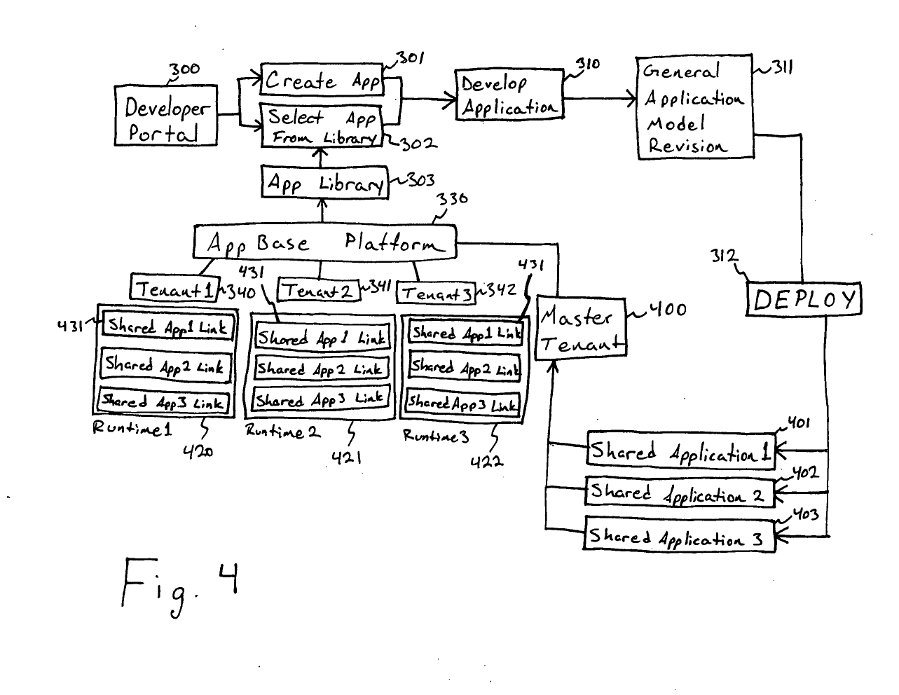

FIG. 4 is a block diagram showing a method for providing shared multitenant applications, according to an embodiment of the invention. The initial steps of FIG. 4 correspond to the same steps in FIG. 3, but FIG. 4 illustrates a variant embodiment that allows for a single application to be shared among multiple tenants (sharing as in all tenants access a same physical location to retrieve the application, and also sharing where a change made by one tenant would be seen by all other tenants using the same version, as opposed to the direct application copying model shown in FIG. 3). To accomplish this, a master tenant 400 is maintained, generally by the operator of DCM platform 100, and shared applications 401-403 are loaded therein, rather than in individual tenant runtime environments 420-422. Then, each tenant configures its runtime tenant environment 420-422 with a link 431 to one or more of shared applications 401-403. It will be appreciated that, for applications having very broad applicability (such as change of address applications), it may be desirable from a configuration management point of view to maintain a single, easy-to-maintain, copy of each shared application 401-403 rather than having each tenant maintain its own independent copy as in FIG. 3.

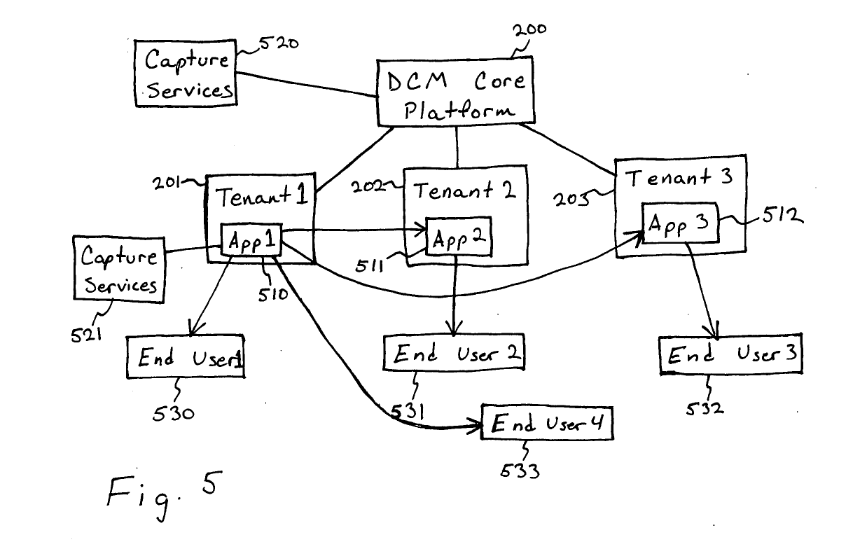

Because of the multitenant, cloud-based architecture of DCM platform 100, many variations are contemplated by the inventor, and in fact DCM platform 100 is in general considered capable of delivering novel DCM solutions that were heretofore impossible or extremely difficult (and expensive) to carry out. For example, and referring to FIG. 5, it is possible according to an embodiment of the invention to carry out (as suggested above) a multi-enterprise business process—that is, a business process carried out using people and resources of a plurality of distinct business entities (enterprises). In one embodiment, tenant 1 201 implements a DCM application 510 within its runtime DCM environment. Like most DCM applications, application 510 is carried out in distinct phases, starting with opening a new case, then processing the case, and finally closing the case. In most applications, during opening and processing phases, it is necessary to “capture” documents or other artifacts using capture services 520, 521. Capture services include fax servers such as high-speed automatic fax processing devices, scanners including high-speed automatic scanners, optical character recognition software modules, email processors, and online forms, and may be deployed by a tenant in its own facilities (capture services 521) or as an additional service provided by DCM core platform 200 (capture services 520). Similarly, archive services may be optionally provided, such as long-term storage on tape, disk, or storage arrays using any storage technology known in the art.

In the exemplary embodiment illustrated in FIG. 5, user 530 interacts with application 510 (often as a case manager, although user 530 could be involved in any number of roles, and more than one user from tenant 201 can certainly be used). In some cases, as shown in FIG. 5, applications make use of other applications to provide one or more functional services, or to carry out a portion of an overall case workflow; that is, applications may be designed and executed in a hierarchical or ad hoc, networked fashion. In some situations one application is a governing application for a given case or class of cases, while in other situations the role of managing a case may actually move automatically from one application to a peer application. In FIG. 5, application 510 is designed to make use of services provided by application 2 511 operating within and on behalf of tenant 2 202, with involvement of user 2 531, who is part of tenant 2 202's business organization. Similarly, application 3 512 operated by tenant 3 203 and using user 3 532 (part of tenant 3 203's organization), is used in conjunction with application 1 510. Either of application 2 511 and application 3 512 may be used as a dependent, or subordinate, application from the perspective of application 1 510's business process logic, or either of application 2 511 or application 3 512 may be used as peer applications that assume control of a case for at least a portion of the overall business process used to manage the case. Finally, in some cases end user 4 533, who is not associated with any tenant, may participate, whether as a subcontractor or as an independent provider of a specialized on-demand service, under control of application 1 510 (or indeed of any of the applications 510-512).

It should be noted that many possible business arrangements between tenants and service providers (such as user 4 533) are contemplated by the inventor according to the invention. For instance, tenant 2 202 may be contractually obligated to perform certain functions while appearing to a consumer as if it were a part of tenant 1 201's enterprise. On other cases, some consumer needs may be quite complex and ad hoc, and require unrelated services to be carried out by one or more of tenants 1-3 201-203, although often one of the tenants acts as “prime contractor” and is perceived by the requesting consumer as the enterprise from whom the services are being received. In some embodiments, one or more of tenants 2,3 202, 203 and the like may act as outsourcers, taking on responsibility for fulfilling demand for one or more sub-processes (such as address changes), and doing so for a range of enterprises (tenant 1 201 in the example of FIG. 5).

In some cases, such as when specialized services are provided by end user 4 533, DCM core platform 200 may act as a broker and reputation manager and maintain a register of qualified specialized service providers, including their rates and their reputations, so that tenant 1 201, for example, could simply request from DCM core platform 200, “please get me a qualified accountant with at least a 98% feedback score to review this document”, and user 4 533 would be incorporated as a part of the overall business process managed by application 1 510 directly. In such cases, payment may be made from tenant 1 201 to DCM core platform 200 for the accounting services, and DCM core platform 200 would pay end user 4 533 his appropriate fee.

It will be appreciated by one having ordinary skill in the art that many variations are possible, essentially including and kind of composition of direct and indirect services provided by one or more tenants in order to meet a customer's need. Thus, as envisioned by the inventor, a DCM platform 100 would be able to provide an application library containing a wide range of prebuilt templates and ready-to-use applications, and to act as a broker between enterprises who need to efficiently carry out complex business processes and third party service providers who may desire to provide specialized services on an ad hoc basis for a wide range of enterprises with a minimum of technology overhead.

All of the embodiments outlined in this disclosure are exemplary in nature and should not be construed as limitations of the invention except as claimed below.

What is claimed is:

1. A dynamic case management system, comprising:
a configuration server;
a dynamic case management application development platform, comprising:
a business object builder;
a presentation builder;
a rule builder;
a report builder;
a dashboard builder; and
a business process builder;
a dynamic case management model store; and
a multitenant runtime platform, comprising:
a business data server;
a rules processor;
a content management server;
a desktop renderer;
a report server;
a dashboard server;
an audit server;
an alert server;
a runtime security server;
wherein the runtime platform is adapted to operate in either of a shared multitenant application deployment model and a direct multitenant application deployment model.

2. A dynamic case management system, comprising:
a dynamic case management application development platform, the development platform comprising one or more of a business object builder, a presentation builder, a rules builder, a report builder, a dashboard builder, and a business process builder; and
a multitenant runtime platform, the runtime platform comprising one or more of a business data server, a rules processor, a content management server, a desktop renderer, a report server, a dashboard server, an audit server, and a runtime security server;
wherein the runtime platform is adapted to operate in either of a shared multitenant application deployment model and a direct multitenant application deployment model.

3. The system of claim 1, further comprising a library of dynamic case management applications, the library enabling users of the development platform to retrieve a pre-build dynamic case management application from the library for use or customization by the user.

4. The system of claim 3, wherein the library makes available to one or more users a plurality of dynamic case management applications from third-party application developers.

5. The system of claim 1, wherein the development platform enables development of, and the runtime platform enables execution of, chained or multi-tiered applications.

6. The system of claim 5, wherein the chained or multi-tiered applications comprise applications from at least two distinct corporate entities.

7. The system of claim 6, wherein one of the corporate entities is the operator of the runtime platform.

8. The system of claim 1, wherein the runtime platform enforces a shared, role-based security model across multiple tenants.

9. The system of claim 2, further comprising a library of dynamic case management applications, the library enabling users of the development platform to retrieve a pre-build dynamic case management application from the library for use or customization by the user.

10. The system of claim 9, wherein the library makes available to one or more users a plurality of dynamic case management applications from third-party application developers.

11. The system of claim 2, wherein the development platform enables development of, and the runtime platform enables execution of, chained or multi-tiered applications.

12. The system of claim 11, wherein the chained or multi-tiered applications comprise applications from at least two distinct corporate entities.

13. The system of claim 12, wherein one of the corporate entities is the operator of the runtime platform.

14. The system of claim 2, wherein the runtime platform enforces a shared, role-based security model across multiple tenants.

15. A method for developing and deploying dynamic case management applications in a cloud-based service, the method comprising the steps of:
(a) creating a new dynamic case management application within a developer portal, or optionally loading a pre-built application from a dynamic case management application library accessed via the developer portal;
(b) further developing the dynamic case management application within the developer portal using at least one of a business object builder, a presentation builder, a rules builder, a report builder, a dashboard builder, and a business process builder;
(c) generating a unique dynamic case management application revision for the dynamic case management application developed in step (b); and
(d) deploying the application into a dynamic case management runtime platform, the platform comprising at least one of a business data server, a rules processor, a content management server, a desktop renderer, a report server, a dashboard server, an audit server, and a runtime security server.

16. The method of claim 15, further comprising the step of loading a copy of the deployed dynamic case management application into a tenant runtime environment.

17. The method of claim 15, wherein step (d) further comprises deploying the dynamic case management application into a master tenant within the runtime platform.

18. The method of claim 17, further comprising the step of loading a link to the deployed dynamic case management application into a tenant runtime environment.
